(19) United States
(12) Patent Application Publication
(10) Pub. No.: US 2009/0267416 A1
(43) Pub. Date: Oct. 29, 2009

(54) ARRANGEMENT RELATING POWER BACKUP AND METHOD FOR POWER BACKUP

(75) Inventor: Andreas Wilson, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/111,604

(22) Filed: Apr. 29, 2008

(51) Int. Cl. H02J 1/00

(52) U.S. Cl. 307/39

(57) ABSTRACT

An arrangement and method for eliminating power failures, especially due to glitches, in a device is provided. The arrangement may include electrical components configured to be supplied with power, a power source for supplying the components, a capacitive element configured to provide a flash element with operational power. The arrangement may include a device for sensing power supplied from the power source, and means for redirecting power from the capacitive element to the electrical components when a power from the power source reduces to a predetermined level.

### TECHNICAL FIELD

The present invention generally relates to providing a charging capacitor and using the charging capacitor as a backup power source.

### BACKGROUND OF THE INVENTION

Communication devices, such as cellular telephones, are becoming increasingly versatile. For example, cellular telephones today often include applications that allow users to do more than just make and receive telephone calls, such as send/receive text messages, play music, play video games, take pictures, etc. Consequently, cellular telephones have become an increasingly common part of every day life for a large number of cellular telephone users.

The functionality of taking pictures and consumer demands imply that more sufficient camera units are incorporated in the mobile phone. It is not unusual for cameras to be of high quality with superior resolution also allowing simple or high quality flash function using an intensive light emitting portion. The flash device is usually an ordinary or modified camera flash using a flash capacitor.

Naturally, in all electrical devices, supplying power to the electrical components is an essential function. For mobile devices, in particular, the device is exposed to motion and vibrations which may affect performance of at least some functions of the device. Typically, the battery connects to the electronic components using non-fixed connectors, which may glitch and result in malfunction of the device.

It is believed that on/off problems, especially due to glitches, are one of the major sources of user dissatisfaction with a device, which results in high rate return for a particular product.

FIG. 1 illustrates a device 100, such as a mobile phone, including a housing 101, a power source such as a battery 110, a camera portion 120, controlling electronics 130, a voltage transforming circuit 140, a flash 150, and a flash capacitor 160.

The device may include other electrical components/circuitry, e.g. transceiver and interface circuits in case of a mobile phone, well known to a skilled person, which are not described herein.

A capacitor charging device for a flash, for example, disposed in a digital camera is used to charge the flash capacitor of the digital camera so as to provide electricity for producing the flash. As shown in the example of FIG. 2, the charging device may include a flash capacitor 260, a voltage transforming circuit 240, a current mode pulse width modulation (PWM) control circuit 231, and a charging control circuit 232. Voltage transforming circuit 240 may further include a transformer 241, a diode D1, a resistor R1, and a transistor (MOSFET) Q1.

When the charging device is initially activated, current mode PWM control circuit 231 may output a pulse current I to control the gate-to-source voltage VGS. Charging control circuit 232 may control the pulse width of current I with a time control capacitor (not shown). Since the capacitance of the time control capacitor is small, the soft start period (i.e., the period for reaching the maximum pulse width of current I) of current mode PWM control circuit 231 is very short. Hence, current mode PWM control circuit 231 can output pulse current I with maximum pulse width in a relatively short time.

When pulse current I is “on” (i.e., a state with an output current), gate-to-source voltage VGS of MOSFET Q10 may be positive and result in an increase of current ID passing through MOSFET Q10. While current ID increases, transformer 231 may generate an induced current I₀ to charge flash capacitor 260. When pulse current I is “off” (i.e., a state with no output current), gate-to-source voltage VGS of MOSFET Q1 may be zero and result in the decrease of current I₀. While current I₀ decreases, due to the tremendous reverse resistance of diode D10, induced current I₀ may also reduce to zero. Thereby, flash capacitor 260 can be charged by induced current I₀ in the on-off cycle of pulse current I.

### SUMMARY OF THE INVENTION

Embodiments of the present invention provide a solution for power backup, which eliminates the problems with on/off due to power failure, e.g., because of power source connection glitches.

Thus, the present invention according to a first aspect of the invention relates to a method in a device including electrical components configured to be supplied with power from a power source, the device including a capacitive element configured to provide a flash with operational power, the method including the steps of: sensing power from the power source, redirecting power from the capacitive element to the electrical components if a power supply failure is detected, and adjusting power level from the capacitive element to a level consumable by the electrical components. The capacitive element may include a flash capacitor.

The invention also relates to an arrangement in a device including: electrical components configured to be supplied with power, a power source for supplying the components, a capacitive element configured to provide a flash element with operational power. The arrangement includes: a device for sensing power supplied from the power source, and means for redirecting power from the capacitive element to the electrical components when power from the power source reduces to a predetermined level. The arrangement may further include a power transformer for adjusting power level from the capacitive element to a level consumable by the electrical components. The power supply may be a battery. The capacitive element may be a flash capacitor. The arrangement may further include a controller circuit and a switching arrangement. The controller circuit receives information about the power supply of the power source to the electrical components. The switching arrangement may be configured to supply power from the power source to components that need electricity. A power backup controller arrangement may be configured to control a power transforming circuit so that power stored in the capacitive element is transformed down to a level usable by the electrical circuits.

According to another aspect of the invention a device may include an image recording arrangement and a flash light, a capacitor for powering the flash light and a power source which are provided. The device may further include an arrangement including: a device for sensing power supplied from the power source, and means for redirecting power from the capacitive element to the electrical components when a power from the power source reduces to a predetermined level. The device may further include a communication portion for communicating in a communication network. The device may further include a housing, a display, control buttons, and a keypad. The device may further include charging control circuit, a voltage mode circuit, a voltage transforming circuit, a power direction control arrangement, and a power directing switch arrangement. In an embodiment for charging the capacitor, when the voltage across the flash capacitor is low, the charging control circuit may be arranged to provide a low voltage to activate the voltage mode control circuit, which may be arranged to output a voltage, the voltage mode control circuit may be arranged to provide a constant current to charge a capacitor of the charging control circuit, whereby the voltage mode control circuit may be arranged to increase a pulse width of the pulse voltage according to a voltage across the capacitor, the pulse voltage may drive the voltage transforming circuit to provide an induced current to charge the flash capacitor. The power backup controlling arrangement may redirect the function of the power transforming circuit so that the power stored in the flash capacitor may be transformed down to a suitable level for other electrical circuits in the device.

### BRIEF DESCRIPTION OF THE DRAWINGS

The accompanying drawings, which are incorporated in and constitute a part of the specification, illustrate an embodiment of the invention and, together with the description, explain the invention. In the drawings:

FIG. 1 illustrates schematically a state of the art solution;

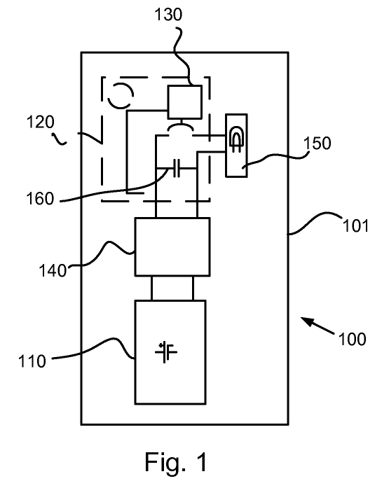

FIG. 2 illustrates schematically an embodiment according to the present invention;

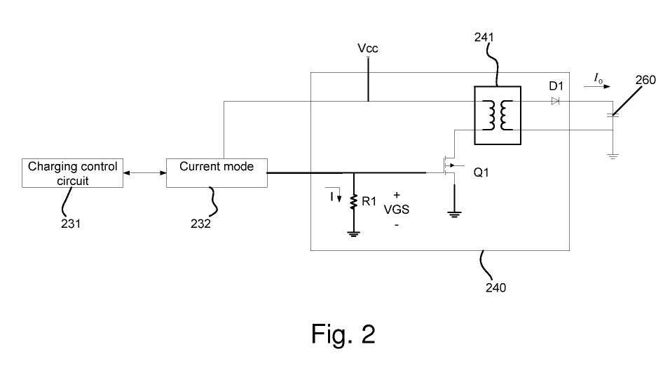

FIG. 3 illustrates a device incorporating an arrangement according to the present invention; and

FIG. 4 illustrates a device incorporating an arrangement according to the present invention in further detail.

### DETAILED DESCRIPTION OF PREFERRED EMBODIMENTS

A “device,” as the term is used herein, is to be broadly interpreted to include a radiotelephone; a personal communications system (PCS) terminal that may combine a cellular radiotelephone with data processing, a facsimile, and data communications capabilities; a personal digital assistant (PDA) that can include a radiotelephone, pager, Internet/intranet access, web browser, organizer, calendar, a camera (e.g., video and/or still image camera), a sound recorder (e.g., a microphone), a Doppler receiver, and/or global positioning system (GPS) receiver; a laptop; a GPS device; a camera (e.g., video and/or still image camera); a sound recorder (e.g., a microphone); and any other computation or communication device capable of presenting media, such as a personal computer, a home entertainment system, a television, etc.

A “glitch,” as the term is used herein, is to be broadly interpreted to include power supply failure, reduction, interruption, surge and/or other undesirable fluctation.

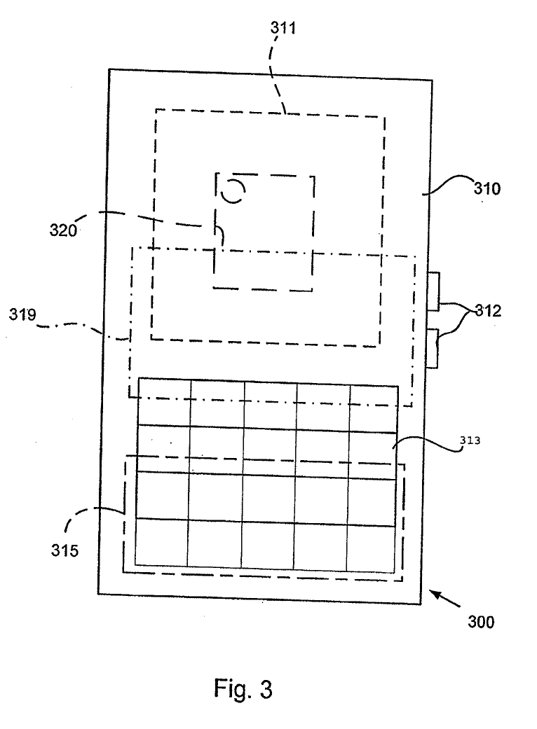

As shown in FIG. 3, an exemplary device 300 may include a housing 310, a display 311, control buttons 312, a keypad 313, a communication portion 314, a battery 315, and a camera 320. Housing 310 may protect the components of device 300 from outside elements. Display 311 may render visual information to the user. For example, display 311 may present information regarding incoming or outgoing calls, media, games, phone books, the current time, etc. Control buttons 312 may permit the user to interact with a device to cause the device to perform one or more operations. Keypad 313 may include a standard telephone keypad. Camera 320 may enable a user to capture and store video and/or images (e.g., pictures). The function of the camera unit together with the power backup system according to the present invention will be described in more detail below. The communication portion may include components (not shown) such as a receiver, a transmitter, an antenna, etc., for establishing and performing communication with one or several communication networks.

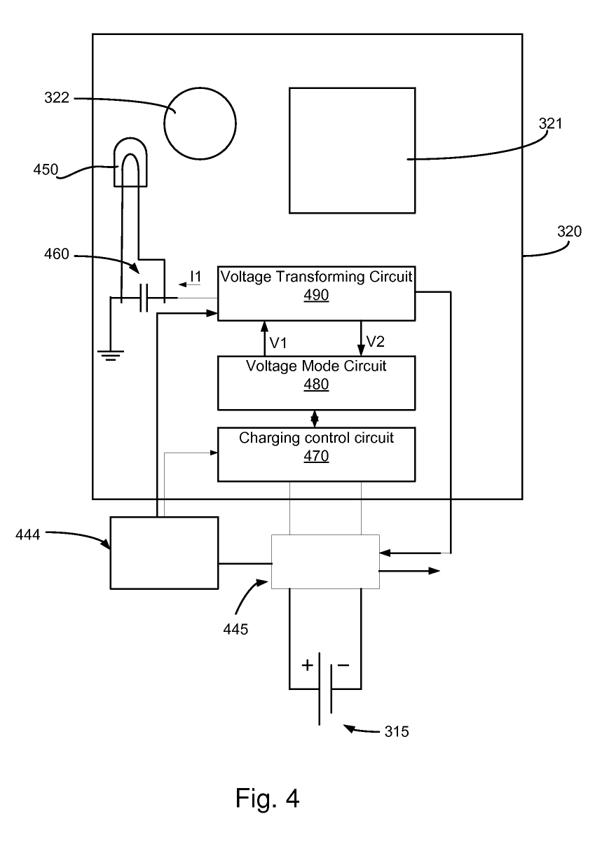

Camera portion 320 in conjunction with the power backup portion according to the present invention, as illustrated in FIG. 4, may include image capturing electronics 321, a camera lens 322, a flash 450, a flash capacitor 460, a charging control circuit 470, a voltage mode circuit 480, a voltage transforming circuit 490, a power direction control arrangement 444, and a power directing switch arrangement 445. It should be noted that voltage mode circuit 480 may be omitted or substituted with another type of voltage controlling arrangement.

The operation of the camera per se is assumed to be well known by a skilled person and not described herein in detail.

For charging the capacitor, when voltage across flash capacitor 460 is low, charging control circuit 470 may provide a low voltage to activate voltage mode control circuit 480 and make it output (pulse) voltage V1. Then, voltage mode control circuit 480 may provide a constant current to charge a capacitor (not shown) of charging control circuit 470. At the same time, voltage mode control circuit 480 may increase a pulse width of pulse voltage V1 according to the voltage across the capacitor. Pulse voltage V1 drives voltage transforming circuit 490 to provide induced current I1 to charge flash capacitor 460. When flash capacitor 460 is charged completely, voltage transforming circuit 490 may provide a high voltage V2 to prevent voltage mode PWM control circuit 480 from outputting pulse voltage V1.

The arrangement of the invention according to this embodiment may further include a controlling circuit 444 and a switching arrangement 445. The controlling circuit 444 may receive information about the power supply of the power source, e.g., battery 315 to the electrical components, such as the transceiver portion, of the device. During normal operation of the device, switching arrangement 445 may be controlled to supply power from the battery to all components that need electricity. If a power failure, e.g., due to a glitch, is detected, power backup controlling arrangement 444 may redirect the function of power transforming circuit 490 so that the power stored in capacitor 460 may be transformed down to a suitable level for the electrical circuits in other portions of the device. Switch arrangement 445 may be controlled to redirect the stepped-down power from flash capacitor 460 to one or more electronics of the device.

By doing so, the effect of the power failure is minimized and the circuits needing power for their operation are maintained operable.

The invention may detect the power glitches using a low voltage and/or current detector. A detector may be used to detect a power reduction down to a predetermined threshold value.

It should be appreciated that the up/down transformation of the power to/from the capacitor may be needed where the capacitor is charged and discharged with higher voltage/current for operating the flash than other ones of the electronic components. Thus, in cases where the electronics of the device operate with same voltage current level as the capacitor, the power may be supplied to the electronics without further stepping down the power.

Clearly, other capacitive elements can be used in same way as the flash capacitor.

It should be noted that the word “comprising,” “comprises,” “including,” and “include” do not exclude the presence of other elements or steps than those listed and the words “a” or “an” preceding an element do not exclude the presence of a plurality of such elements. It should further be noted that any reference signs do not limit the scope of the claims, that the invention may be implemented at least in part using hardware, software, and firmware, and that several “means,” “units,” or “devices” may be represented by the same item of hardware.

The above-mentioned and described embodiments are only given as examples and should not be limiting to the present invention. Other solutions, uses, objectives, and functions within the scope of the invention as claimed in the below-described patent claims, should be apparent for the person skilled in the art.

1-19. (canceled)

20. In a device including electrical components configured to be supplied power from a power source, a flash, and a capacitive element configured to provide the flash with operational power, the method comprising:
sensing a supply of power from the power source;
detecting a glitch in the supply of power; and
redirecting the operational power from the capacitive element to one or more of the electrical components based on the detected glitch in the supply of power.

21. The method of claim 20, further comprising:
adjusting a power level of the redirected operational power to a level that is consumable by the electrical components.

22. The method of claim 20, wherein the capacitive element comprises a flash capacitor.

23. A device comprising:
electrical components configured to be supplied with power;
a power source for supplying the power to the electrical components;
a capacitive element configured to provide a flash element with operational power; and
an arrangement including:
a device to sense the power from the power source, and
a switch arrangement to redirect the operational power from the capacitive element to the electrical components when the power from the power source is below a predetermined level.

24. The device of claim 23, further comprising:
a power transformer to adjust a power level of the redirected operational power from the capacitive element to a level that is consumable by the electrical components.

25. The device of claim 23, wherein the power supply is a battery.

26. The device of claim 23, wherein the capacitive element is a flash capacitor.

27. The device of claim 23, wherein the device to sense the power from the power source comprises a controller circuit.

28. The device of claim 27, wherein the controller circuit is configured to receive information about the supply of the power to the electrical components.

29. The device of claim 27, wherein the switching arrangement is configured to supply the power from the power source to those of the electrical components that are in need of the power.

30. The device of claim 23, further comprising:
a power backup controller arrangement configured to control a power transforming circuit so that the redirected operational power from the capacitive element is transformed down to a level that is usable by the electrical components.

31. A device including an image recording arrangement, a flash unit, a capacitor for powering the flash unit, and a power source, the device further including an arrangement comprising:
means for sensing power supplied from the power source; and
means for redirecting power stored in the capacitor to the electrical components when a supply of power from the power source is sensed to be at a predetermined level.

32. The device of claim 31, further comprising:
means for communicating within a communication network.

33. The device of claim 31, further comprising:
a housing;
a display;
control buttons; and
a keypad.

34. The device of claim 31, further comprising:
a charging control circuit;
a voltage mode circuit; and
a voltage transforming circuit.

35. The device of claim 31, wherein the means for redirecting power comprises a power direction control arrangement and a power directing switch arrangement.

36. The device of claim 34, wherein for charging the capacitor, when the voltage across the capacitor is low, the charging control circuit is configured to provide a low voltage to activate the voltage mode control circuit, which is configured to output a voltage, the voltage mode control circuit being configured to provide a constant current to charge a capacitor of the charging control circuit, the voltage mode control circuit being configured to increase a pulse width of the pulse voltage based on a voltage across the capacitor, the pulse voltage to drive the voltage transforming circuit to provide an induced current to charge the flash capacitor.

37. The device of claim 31, wherein the power backup controlling arrangement is configured to redirect the function of the power transforming circuit so that the power stored in the capacitor is transformed down to a suitable level for other electrical circuits in the device.

38. The device of claim 31, wherein the device comprises a radiotelephone; a personal communications system (PCS) terminal combining a cellular radiotelephone with data processing, facsimile, and data communications capabilities; a personal digital assistant (PDA); a camera; a sound recorder; a Doppler receiver; a global positioning system (GPS) receiver; a laptop computer; or a GPS device.
